(19) United States
(12) Patent Application Publication
(10) Pub. No.: US 2009/0000669 A1
(43) Pub. Date: Jan. 1, 2009

(54) Fuel cutoff valve

(75) Inventors: Hiroaki Kito, Aichi-ken (JP); Kenichiro Kaneko, Aichi-ken (JP); Hiroshi Nishi, Aichi-ken (JP); Shoichiro Kumagai, Wako-shi (JP); Hiroshi Kitamura, Wako-shi (JP); Yasuhiro Hasegawa, Wako-shi (JP); Shoji Uhara, Wako-shi (JP)

Correspondence Address: POSZ LAW GROUP, PLC, 12040 SOUTH LAKES DRIVE, SUITE 101, RESTON, VA, 20191, US

(73) Assignees: TOYODA GOSEI CO., LTD., Aichi-ken (JP); HONDA R&D CO., LTD., Wako-shi (JP)

(21) Appl. No.: 12/213,980

(22) Filed: Jun. 26, 2008

(30) Foreign Application Priority Data
Jun. 29, 2007 (JP) 2007-171746

(51) Int. Cl. F16K 24/04

(52) U.S. Cl. 137/202

(57) ABSTRACT

A fuel cutoff valve 10 has a float assembly 52 and an upper valve plug 60 located in a valve chest 30S defined by a casing 20. The float assembly 52 has a valve support member 55 formed in its upper portion to support the upper valve plug 60. The upper valve plug 60 has a support convex 66b held on a support plane 56a of the valve support member 55, where a center of gravity of the upper valve plug 60 is located below a supporting point 55a around which the support convex 66b is balanced on the valve support member 55. The upper valve plug 60 includes a first valve section 61 and a second valve section 65. The first valve section 61 has a first valve body 62 and a sheet member 64. The first valve body 62 is made of POM (polyoxymethylene), while the second valve section 65 is made of PA6 (polyamide) containing 30% of glass fibers. The second valve section 65 is accordingly structured to have a lower density than the first valve body 62. This arrangement ensures the excellent sealing property even in the event of vibration of the fuel cutoff valve 10 submerged in the liquid fuel by inclination of the vehicle body.

### CROSS REFERENCE TO RELATED APPLICATIONS

The present application claims the priority based on Japanese Patent Application No. 2007-171746 filed on Jun. 29, 2007, the disclosure of which is hereby incorporated by reference in its entirety.

### BACKGROUND OF THE INVENTION

1. Field of the Invention

The present invention relates to a fuel cutoff valve attached to an upper portion of a fuel tank and configured to open and close a connection conduit for connecting inside of the fuel tank with outside and thereby allow and block communication of the inside of the fuel tank with the outside.

2. Description of the Related Art

A connection conduit for letting the fuel vapor off to a canister is conventionally provided in an upper portion of a fuel tank. A fuel cutoff valve is attached to the connection conduit. The fuel cutoff valve has a float placed in a valve chest to move up and down with an increase or a decrease of buoyancy according to a variation in liquid fuel level. An upper valve plug for opening and closing a valve seat is generally provided above the float (see, for example, JP-A 7-279789). The raised liquid fuel level in the fuel tank increases the buoyancy of the float and raises the float integrally with the upper valve plug to close the connection conduit and interfere with the outflow of the liquid fuel.

The flattened fuel tank is the recent trend with requirements for the diversified and widened vehicle interior space. The fuel cutoff valve attached to the flattened fuel tank is readily submerged in the liquid fuel, for example, by inclination of the vehicle body. In the event of vibrating the fuel tank with the fuel cutoff valve submerged in the liquid fuel, application of the downward force to the float causes the upper valve plug to be detached from its seal position in the connection conduit and undesirably lowers the sealing property of the fuel cutoff valve.

### SUMMARY

There would thus be a demand for a fuel cutoff valve maintaining excellent sealing property even in the event of vibration in a submerged condition in the liquid fuel, for example, caused by inclination of the vehicle body.

The present invention accomplishes at least part of the demands mentioned above by the following configurations applied to the fuel cutoff valve.

According to one aspect, the present invention is directed to a fuel cutoff valve attached to an upper portion of a fuel tank and configured to open and close a connection conduit for connecting inside of the fuel tank with outside and thereby allow and block communication of the inside of the fuel tank with the outside.

The fuel cutoff valve includes: a casing structured to form a valve chest of connecting the fuel tank with the connection conduit; a float assembly located in the valve chest and configured to move up and down along a vertical axis with an increase or a decrease of buoyancy corresponding to a variation in level of liquid fuel in the valve chest; and an upper valve plug placed above the float assembly to be movable along the vertical axis in a preset distance Dm from the float assembly and configured to open and close the connection conduit by a downward motion and an upward motion of the float assembly under a condition that the liquid fuel reaches a predetermined fluid level.

The upper valve plug has: a first valve section including (i) a first valve body designed to have a support hole, (ii) a first seat element provided on the first valve body to open and close the connection conduit, and (iii) a connection hole formed to pass through the first seat element and connect with the support hole and designed to have a smaller passage area than a passage area of the connection conduit; and a second valve section including (i) a second valve body located in the support hole to be movable along the vertical axis and (ii) a second seat element provided on the second valve member to open and close the connection hole. The second valve section is structured to have a lower density than the first valve body.

With an increase in liquid fuel level in the fuel tank in the course of fuel supply to the fuel tank equipped with the fuel cutoff valve according to the above aspect of the invention, the liquid fuel flowed into the valve chest applies the buoyancy to raise the float assembly integrally with the upper valve plug. With the rise of the upper valve plug, the seat member of the upper valve plug closes the connection conduit to block the fuel tank from the outside and thereby prevent the outflow of the liquid fuel from the fuel tank to the outside. In the course of opening the connection conduit by the motion of the upper valve plug, the connection hole having the smaller passage area than the connection conduit is opened prior to the second valve section. This reduces the force applied to the first valve section in the valve-closing direction and promptly opens the connection conduit, thereby ensuring the excellent valve re-opening property.

In the event of vibrating the fuel tank with the upper valve plug of the fuel cutoff valve submerged in the liquid fuel, application of the downward force to the float assembly pulls down the upper valve plug integrally with the float assembly. The second valve section of the upper valve plug is structured to have the lower density than the first valve body. This makes the second valve section likely to remain at the position of closing the connection hole of the first valve section. Once the second valve section is detached from the first valve section to open the connection hole, the liquid fuel flows into the first valve section to readily open the connection conduit. Since the second valve section is not easily opened as mentioned above, however, even in the event of application of microvibration to the fuel cutoff valve caused by, for example, vibration of the vehicle body, the structure of the fuel cutoff valve keeps the upper valve plug at the seal position of the connection conduit and accordingly maintains the sufficient sealing property.

In one preferable embodiment of the fuel cutoff valve according to the above aspect of the invention, the float assembly has: a first float formed in a cup shape to have a bottom-opened receiving hole; and a second float located in the receiving hole to be integrated with the first float. The second float is structured to have a lower density than the first valve body. In the fuel cutoff valve of this embodiment, the second float as the inner member of the float assembly is structured to have the lower density than the first valve body. This makes the float assembly more buoyant. The upward force of the float assembly further makes the second valve section less likely to open and thus more effectively maintains the sufficient sealing property even in the event of application of vibration to the fuel cutoff valve submerged in the liquid fuel by, for example, inclination of the vehicle body. While the total weight of the float assembly is reduced, the weight of the first float as the outer member of the float assembly is not reduced. The weight reduction of the float assembly accordingly does not lower the abrasion resistance of the outside of the float assembly.

In the fuel cutoff valve of this embodiment, the first float may be structured to have a lower density than the first valve body. This arrangement reduces the weight of the whole float assembly and thus makes the float assembly more buoyant.

In another preferable embodiment of the fuel cutoff valve according to the above aspect of the invention, the float assembly has: a first float formed in a cup shape to have a bottom-opened receiving hole; and a second float located in the receiving hole to be integrated with the first float. The first float is structured to have a lower density than the first valve body. This arrangement also makes the float assembly more buoyant and makes the second valve section less likely to open, thus more effectively maintaining the sufficient sealing property.

In one preferable application of the fuel cutoff valve according to the above aspect of the invention, the float assembly has a valve support member formed in an upper portion of the float assembly to support the upper valve plug. The second valve section has a support convex held on the valve support member, where a center of gravity of the second valve section is located below a supporting point around which the support convex is balanced on the valve support member. In the fuel cutoff valve of this application, the support convex formed on the upper valve plug is held at the supporting point on the valve support member located in the upper portion of the float assembly. The center of gravity of the upper valve plug is positioned below the supporting point, so that the upper valve plug is balanced about the supporting point to keep the stable attitude. Even when the float assembly is slanted by, for example, inclination of the vehicle body, the upper valve plug keeps the stable horizontal attitude and is effectively seated on the seal position of the connection conduit, thus maintaining the high sealing property.

In one preferable embodiment of the fuel cutoff valve of this application, the first valve body has a cylindrical side wall, and the second valve body has a guide cylinder located in the first valve body. This simple dual valve structure of the upper valve plug readily attains the balancing function to lower the center of gravity. In the fuel cutoff valve of this embodiment, the first valve body has a first catching claw. The second valve body has a second retaining claw engaging with the first catching claw. A position of engagement of the first catching claw with the second retaining claw is located below the supporting point. This simple structure readily attains the linkage of the first valve section with the second valve section.

### BRIEF DESCRIPTION OF THE DRAWINGS

FIG. 1 is a sectional view showing the structure of a fuel cutoff valve 10 attached to an upper portion of a vehicle fuel tank FT in a first embodiment of the invention;

FIG. 2 is a decomposed sectional view showing the structure of the fuel cutoff valve 10;

FIG. 3 is a decomposed perspective view showing the structure of an upper valve plug 60 and a float assembly 52 in the fuel cutoff valve 10;

FIG. 4 is a decomposed sectional view showing the structure of the upper valve plug 60 and the float assembly 52;

FIG. 5 is an explanatory view showing the function of a float mechanism 50;

FIG. 6 is an explanatory view showing an operation of the fuel cutoff valve 10;

FIG. 7 is an explanatory view showing a subsequent operation of the fuel cutoff valve 10 after the operation of FIG. 6;

FIG. 8 is an explanatory view showing an operation of the fuel cutoff valve 10 submerged in the liquid fuel; and

FIG. 9 is a sectional view showing the structure of an upper valve plug 60A in another fuel cutoff valve of one modified example.

### DESCRIPTION OF THE PREFERRED EMBODIMENTS

In order to clarify the structures, the features, the characteristics, and the functions of the invention, some modes of carrying out the invention are described below as preferred embodiments with reference to the accompanied drawings.
(1) General Structure of Fuel Cutoff Valve 10

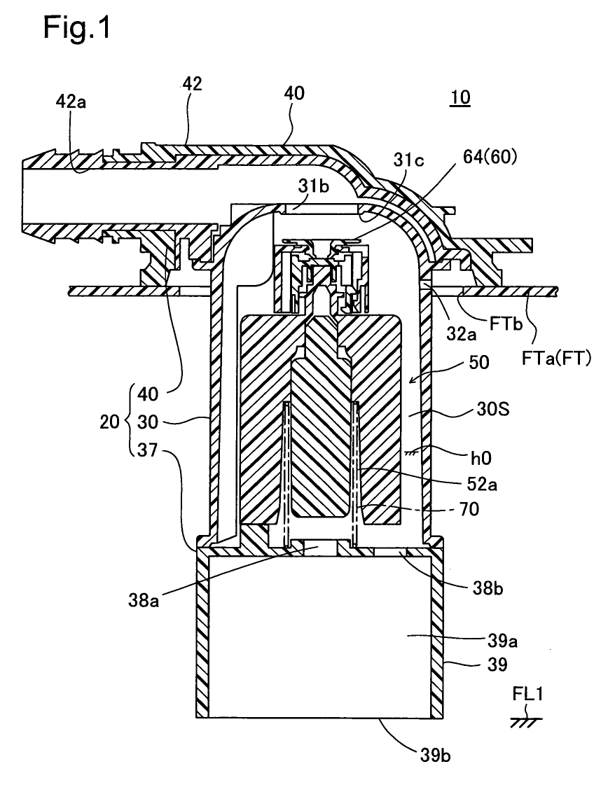

FIG. 1 is a sectional view showing the structure of a fuel cutoff valve 10 attached to an upper portion of a vehicle fuel tank FT in a first embodiment of the invention. The fuel tank FT is made of a composite resin material containing polyethylene in its outer surface layer and has a mounting hole FTc formed in an upper tank wall FTa. The fuel cutoff valve 10 has a lower portion inserted and fit in the mounting hole FTc and is thereby attached to the upper tank wall FTa. When the level of a liquid fuel (gasoline) in the fuel tank FT rises to a predetermined liquid level FL1 in the course of fuel supply, the fuel cutoff valve 10 controls the outflow of the fuel to a canister (not shown).
(2) Detailed Structure of Fuel Cutoff Valve 10

The fuel cutoff valve 10 has a casing 20, a float mechanism 50, and a spring 70 as its main constituents. The casing 20 includes a casing body 30, a bottom member 37, and a cover member 40. The space defined by the casing body 30 and the bottom member 37 forms a valve chest 30S. The float mechanism 50 supported by the spring 70 is located in the valve chest 30S.

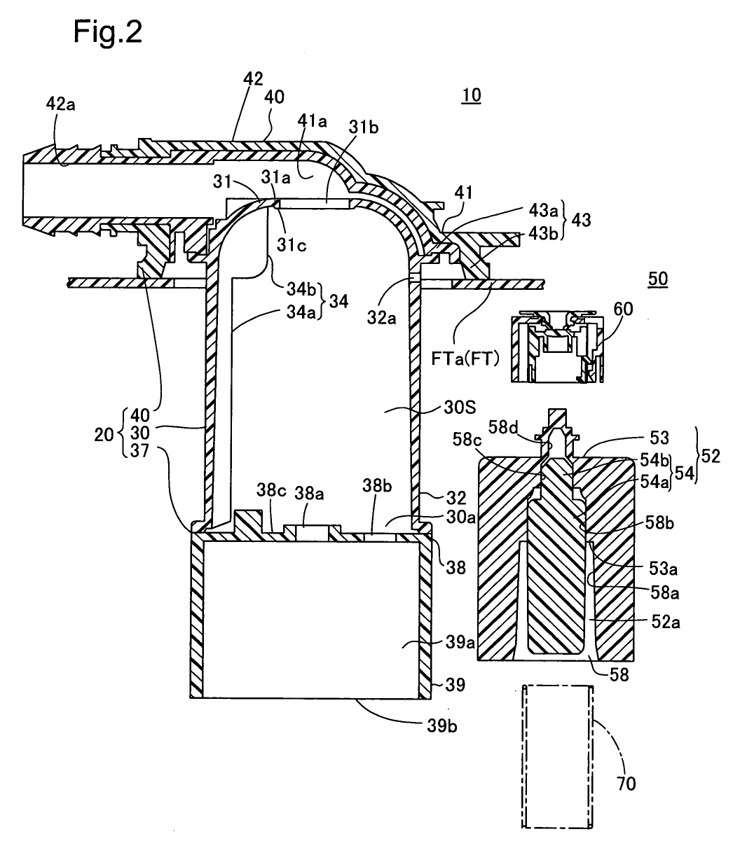

FIG. 2 is a decomposed sectional view showing the structure of the fuel cutoff valve 10. The casing body 30 is formed in a cup shape defined by a ceiling wall member 31 and a side wall member 32 and has a bottom opening 30a. A conduit forming projection 31a protruded downward is formed in a center area of the ceiling wall member 31. A connection conduit 31b is formed to pass through the conduit forming projection 31a. One end of the connection conduit 31b close to the valve chest 30S forms a first sealing element 31c. The side wall member 32 has a first connection hole 32a formed to connect the inside of the fuel tank FT with the valve chest 30S. The inner face of the side wall member 32 has four ribs arranged along its circumference and formed as case guide elements 34 for guiding the float mechanism 50. Each of the case guide elements 34 has a lower guide rib 34a formed in the lower portion of the casing body 30 and an upper guide rib 34b protruded more inward toward the axial center than the lower guide rib 34a.

The bottom member 37 is provided to close part of the bottom opening 30a of the casing body 30 and to introduce the fuel vapor and the liquid fuel into the valve chest 30S. The bottom member 37 includes a bottom plate 38 integrally formed with a cylindrical section 39. The outer circumference of the bottom plate 38 is welded to a lower end of the casing body 30. The bottom plate 38 has communicating apertures 38a and 38b and a spring support element 38c provided to support a lower end of the spring 70. The cylindrical section 39 forms an introducing conduit 39a to introduce the fuel vapor and the liquid fuel flowed through a lower opening 39b into the valve chest 30S via the communicating aperture 38a.

The cover member 40 includes a cover body 41, a pipe member 42 protruded sideways from the center of the cover body 41, and a flange 43 formed around the outer circumference of the cover body 41. The cover body 41, the pipe member 42, and the flange 43 are formed integrally. The pipe member 42 has a cover conduit 42a. The cover conduit 42a has one end connected via the connection conduit 31b to the valve chest 30S of the casing body 30 and the other end connected to the canister (not shown). A lower end of the cover body 41 forms an inner welding end 43a welded to an upper end of the outer circumference of the casing body 30. A lower end of the flange 43 forms an outer welding end 43b welded to the upper tank wall FTa of the fuel tank FT.

The float mechanism 50 has a dual valve structure of the improved valve re-opening property. The float mechanism 50 has a float assembly 52 and an upper valve plug 60 located above the float assembly 52. The float assembly 52 includes a first float 53 and a second float 54 that are integrally assembled. The first float 53 is formed in a cup shape with a bottom-opened receiving hole 58 to receive the second float 54 fit therein. The receiving hole 58 has four stepped hole sections of upwardly decreasing diameter, a large-diameter hole section 58a, a medium-diameter hole section 58b, a small-diameter hole section 58c, and a smallest-diameter hole section 58d.

The second float 54 includes a cylindrical second float body 54a and a small-diameter cylindrical protrusion end 54b located above the second float body 54a and formed to have a smaller diameter than that of the second float body 54a. The second float 54 is inserted and fit in the receiving hole 58 in such a manner that the second float body 54a and the cylindrical protrusion end 54b are respectively brought into contact with the medium-diameter hole section 58b and with the small-diameter hole section 58c. The first float 53 is thus integrated with the second float 54. A spring support element 53a is formed as a step extended in a radial direction between the large-diameter hole section 58a and the medium-diameter hole section 58b. The spring support element 53a is arranged to support an upper end of the spring 70. The spring 70 is located in a spring receiving space 52a (see FIG. 1) defined by the outer circumference of the second float 54 and the receiving hole 58. The spring 70 is accordingly spanned between the spring support element 38c of the bottom member 37 and the spring support element 53a of the float mechanism 50.

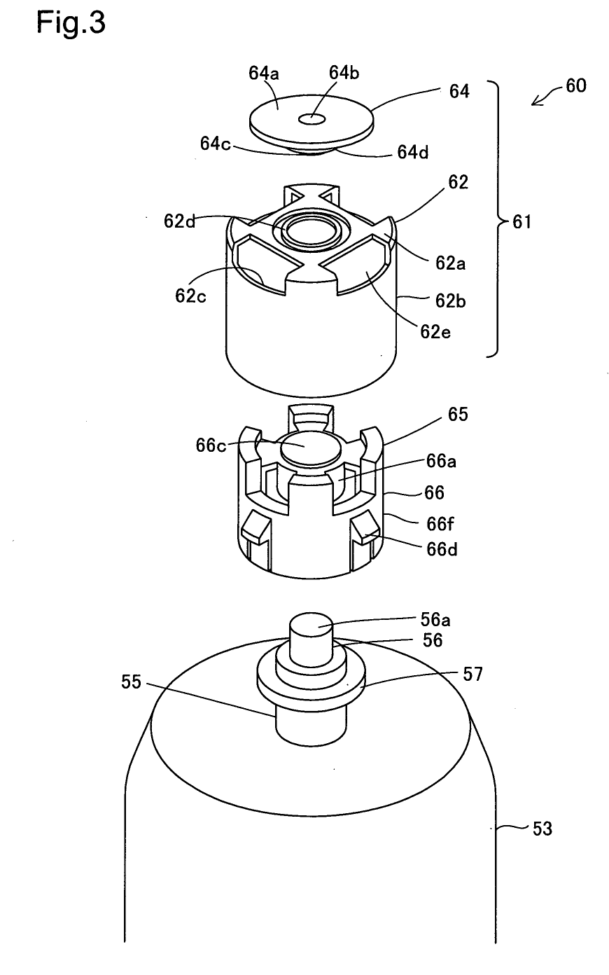

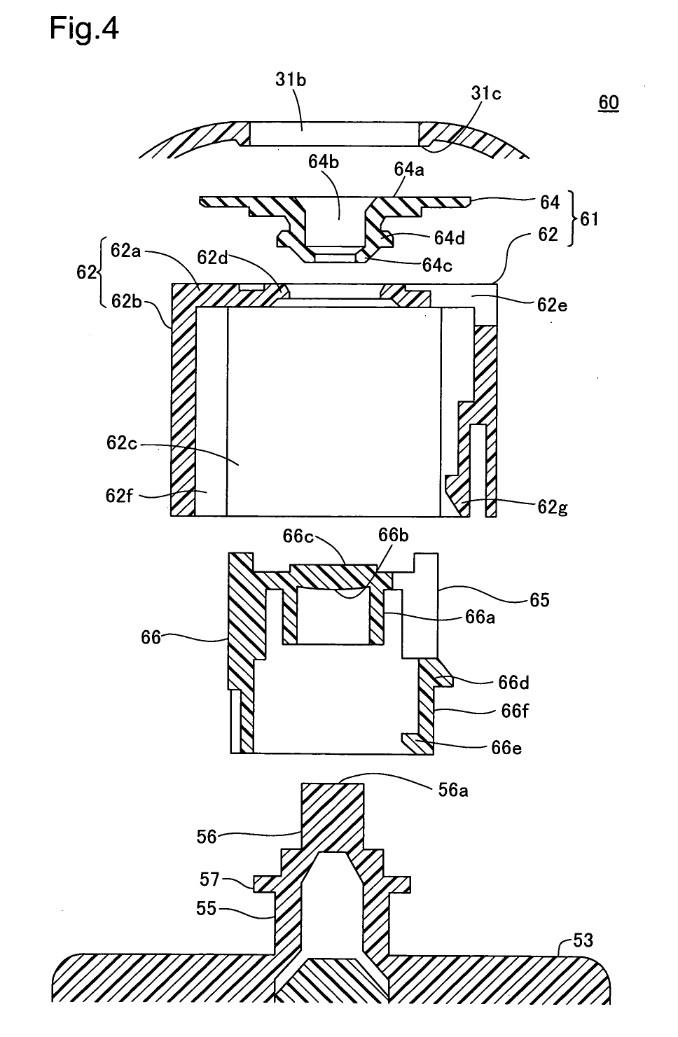

FIG. 3 and FIG. 4 are respectively a decomposed perspective view and a decomposed sectional view showing the structure of the upper valve plug 60 and the float assembly 52. A valve support member 55 is protruded upward from a top face of the first float 53. The valve support member 55 supports the upper valve plug 60 to allow its bobbing motions and has a columnar support projection 56. An upper face of the support projection 56 forms a flat support plane 56a. A ring-shaped projection 57 is formed around the outer circumference of the valve support member 55 to retain the upper valve plug 60.

The upper valve plug 60 includes a first valve section 61 and a second valve section 65 and is supported by the valve support member 55 of the float assembly 52 in such a manner as to allow vertical motions and bobbing motions. The first valve section 61 has a bottomed cylindrical first valve body 62 and a seat member 64 attached to the first valve body 62. The first valve body 62 has a top face 62a and a cylindrical side wall 62b protruded from the outer circumference of the top face 62a. The inner space of the cylindrical side wall 62b forms a supporting hole 62c. A mounting element 62d is provided on the center of the top face 62a to mount and fix the seat member 64. Four communication holes 62e are formed and arranged along the outer circumference of an upper portion of the first valve body 62 to connect the supporting hole 62c to the outside. As shown in FIG. 4, four guide ribs 62f are formed on an inner face of the cylindrical side wall 62b of the first valve body 62 to be extended in the vertical direction and arranged at equal intervals in the circumferential direction. These guide ribs 62f work to guide the second valve section 65 in a vertically movable manner. An elastically deformable first catching claw 62g is formed on the inner face of the cylindrical side wall 62b to catch the second valve section 65.

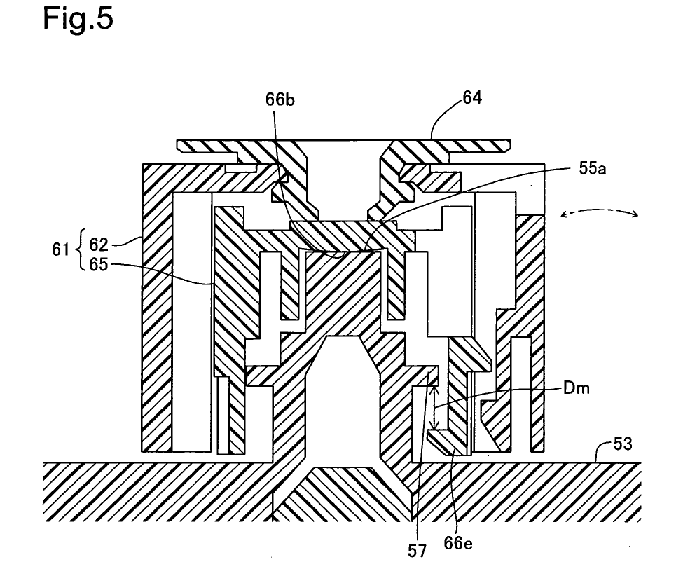

The second valve section 65 has a cylindrical second valve body 66. The second valve body 66 has a bottomed cylindrical partition wall 66a with a lower opening. The support projection 56 is located in the partition wall 66a across a predetermined gap and accordingly prevents significant inclination of the second valve section 65 relative to the float assembly 52. The partition wall 66a has a support convex 66b formed on the center of its top face to be slightly curved downward. The support convex 66b is placed on the support plane 56a of the float assembly 52, so that the second valve section 65 is supported at a supporting point 55a (see FIG. 5) on the support plane 56a to allow the bobbing motions about the supporting point 55a.

The seat member 64 includes a first seat element 64a arranged to be seated on and detached from the first sealing element 31c, a connection hole 64b formed to pass through the center of the first seat element 64a and connect with the supporting hole 62c, a second sealing element 64c formed on a lower end of the connection hole 64b, and a mounting element 64d formed around the outer circumference of the connection hole 64b. The first seat element 64a, the connection hole 64b, the second sealing element 64c, and the mounting element 64d are all made of a rubber material and are integrally formed to the integral seat member 64. The seat member 64 is attached to the first valve body 62 by press fitting the mounting element 64d into the mounting element 62d of the first valve body 62. The first seat element 64a has a gap apart from the top face 62a of the first valve body 62 and is thus elastically deformable to be seated on the first sealing element 31c with the enhanced sealing property.

A second seat element 66c is formed on the top face of the second valve body 66. The second seat element 66c is seated on and detached from the second sealing element 64c of the seat member 64 to close and open the connection hole 64b. Four second retaining claws 66d are formed on a lower portion of a guide cylinder 66f of the second valve body 66. These second retaining claws 66d are caught by the first catching claw 62g of the first valve body 62. The first valve section 61 is accordingly supported on the second valve section 65 to be movable in the vertical direction relative to the second valve section 65. A catching claw 66e is formed on an inner wall of the second valve body 66 to be caught by the ring-shaped projection 57 of the float assembly 52. The second valve section 65 is accordingly supported and retained on the float assembly 52 to be movable in the vertical direction relative to the float assembly 52.

The center of gravity of the upper valve plug 60 is positioned below the support convex 66b. In order to set the center of gravity at this position, the first valve body 62 of first valve section 61 and the second valve body 66 of the second valve section 65 are both formed in the cylindrical shape and are extended below the support convex 66b supported on the support plane 56a.

In the fuel cutoff valve 10 of the embodiment, the main components are made of a resin material, for example, polyethylene, POM (polyoxymethylene), PPS (polyphenylene sulfide), or PA (polyamide) and are designed to satisfy the following characteristics.

The first valve body 62 is made of POM, and the second valve section 65 is made of PA6 containing 30% of glass fibers. The float assembly 52 is constructed as the assembly of the first float 53 made of POM and the second float 54 made of PA6. The 30% content of glass fibers in the PA6 material of the second valve section 65 lowers the high swelling property of PA and improves the abrasion resistance. The first valve body 62, the second valve section 65, the first float 53, and the second float 54 made of the above resin materials respectively have densities of 1.4 [g/cm³], 1.2 [g/cm³], 1.4 [g/cm³], and 1.1 [g/cm³]. In the fuel cutoff valve 10 of the embodiment, the second valve section 65 and the second float 54 are thus characterized by weight reduction to the densities lower than the density of the first valve body 62.

The materials of the first valve body 62, the second valve section 65, and the first float 53 are not restricted to the above resin materials but may be adequately selected out of various resin materials satisfying the above characteristics, for example, polyethylene, POM, PPS, or PA.

FIG. 5 is an explanatory view showing the function of the float mechanism 50. The float assembly 52 is slanted in the direction of an arrow, for example, by inclination of the vehicle body. In this state, since the curved support convex 66b is held at one supporting point 55a on the support plane 56a of the float assembly 52, the second valve section 65 is balanced like a balancing toy. The seat member 64 attached to the first valve member 62 accordingly keeps the horizontal attitude. In the event of application of no buoyancy to the upper valve plug 60, the ring-shaped projection 57 of the float assembly 52 is caught by the catching claw 66e of the upper valve plug 60. The float assembly 52 is independently movable in the vertical direction relative to the second valve section 65 of the upper valve plug 60 in a distance Dm from the above supporting position where the curved support convex 66b of the upper valve plug 60 is held at the supporting point 55a on the support plane 56a of the float assembly 52. The distance Dm is determined by the positional relation between the ring-shaped projection 57 of the float assembly 52 and the catching claw 66e of the upper valve plug 60. From another viewpoint, the second valve section 65 of the upper valve plug 60 is placed above the float assembly 52 to be vertically movable in the distance Dm relative to the float assembly 52.
(3) Operations of Fuel Cutoff Valve 10

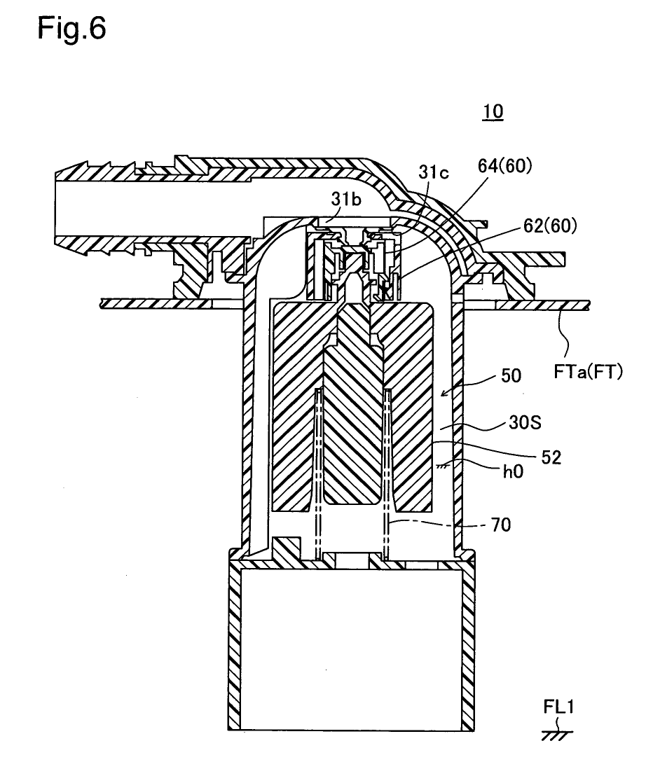

The following describes the operations of the fuel cutoff valve 10. As shown in FIG. 1, in the course of fuel supply into the fuel tank FT, with an increase in liquid fuel level in the fuel tank FT, the fuel vapor accumulated in the upper portion in the fuel tank FT flows through the lower opening 39b and the introducing conduit 39a of the cylindrical section 39 and the communicating apertures 38a and 38b into the valve chest 30S. The fuel vapor then flows from the valve chest 30S through the connection conduit 31b and the cover conduit 42a and is let off to the canister (not shown). When the liquid fuel level in the fuel tank FT reaches the predetermined liquid level FL1, which is equivalent to the position of the opening 39b of the cylindrical section 39, the liquid fuel blocks the opening 39b to increase the inner pressure of the fuel tank FT. In this state, there is a large pressure difference between the inner pressure of the fuel tank FT and the inner pressure of the valve chest 30S. The liquid fuel accordingly flows through the introducing conduit 39a of the cylindrical section 39 and the communicating apertures 38a and 38b into the valve chest 30S. This fuel flow raises the liquid fuel level in the valve chest 30S. When the liquid fuel level in the valve chest 30S reaches a preset height ‘h0’ as shown in FIG. 6, the total of the buoyancy of the float assembly 52 and the upward force by the load of the spring 70 exceeds the downward force by the dead weight of the float mechanism 50. This raises the integral float mechanism 50 and makes the seat member 64 of the upper valve plug 60 seated on the first sealing element 31c to close the connection conduit 31b. In the closed position of the connection conduit 31b, the fuel remains in a fuel filler pipe to be in contact with a fuel gun and activates the auto stop function of the fuel cutoff valve 10. This arrangement of the fuel cutoff valve 10 lets the fuel vapor out of the fuel tank FT while preventing the outflow of the liquid fuel from the fuel tank FT in the course of fuel supply into the fuel tank FT.

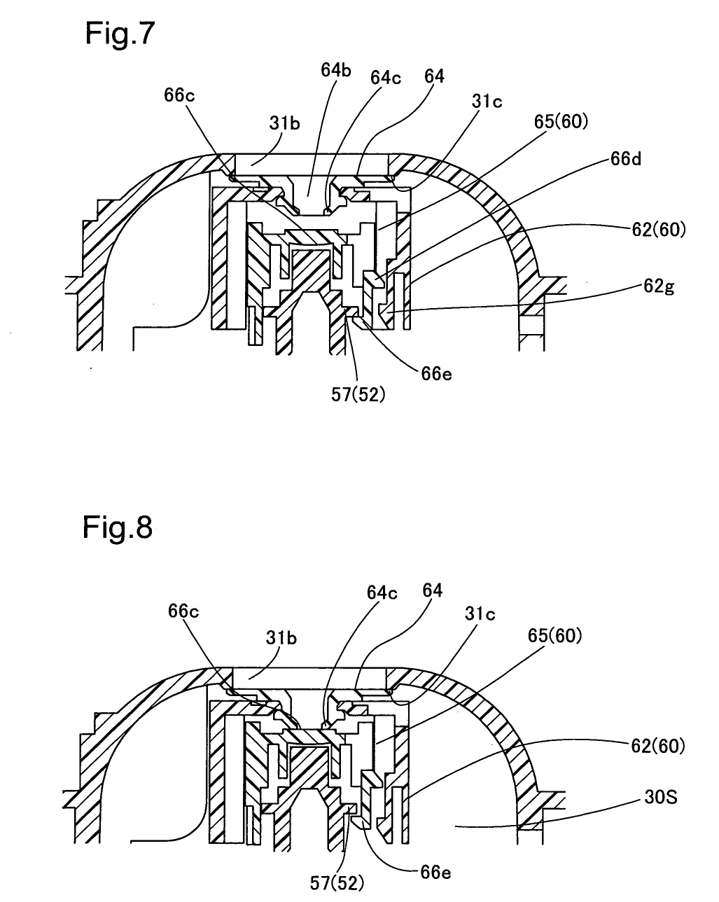

With consumption of the fuel in the fuel tank FT to lower the liquid fuel level, the float assembly 52 decreases its buoyancy and moves down. The lowered float assembly 52 pulls the second valve section 65 down via engagement of the ring-shaped projection 57 of the float assembly 52 with the catching claw 66e of the second valve section 65 as shown in FIG. 7. The second seat element 66c is then detached from the second sealing element 64c to open the connection hole 64b. The opened connection hole 64b causes the pressure below the first valve body 62 to be substantially equivalent to the pressure in the neighborhood of the connection conduit 31b. The first valve section 61 is pulled down together with the second valve section 65 via engagement of the second retaining claws 66d and the first catching claw 62g. As the first valve section 61 moves down, the seat member 64 is detached from the first sealing element 31c to open the connection conduit 31b. This dual valve structure of the first valve section 61 and the second valve section 65 effectively improves the valve re-opening property. As the second sealing element 64c is detached from the second seat element 66c to allow the connection of the connection hole 64b of the reduced passage area, the pressure below the first valve section 61 is reduced to decrease the force of the first valve section 61 in its valve closing direction. This arrangement ensures the enhanced valve re-opening property.

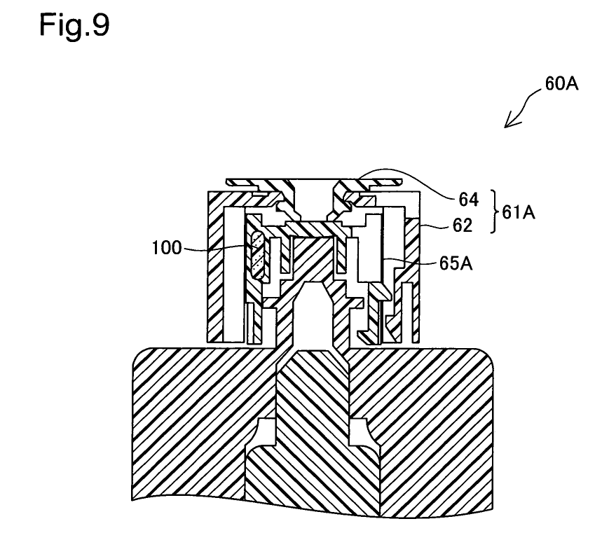

In the inclined attitude of the vehicle body, for example, during hill driving or cornering, the valve chest 30S may be filled with the liquid fuel to submerge the upper valve plug 60 therein. Even when the vibration force of the vehicle running on the uneven road surface is applied to the fuel tank FT in this submerged condition, the fuel cutoff valve 10 ensures the sufficient sealing property between the second sealing element 64c and the second seat element 66c of the upper valve plug 60 as shown in FIG. 8. There is the distance Dm between the ring-shaped projection 57 of the float assembly 52 and the catching claw 66e of the upper valve plug 60 to allow the float assembly 52 to be independently movable in the vertical direction relative to the second valve section 65 of the upper valve plug 60 (see FIG. 5). The float assembly 52 moving down in the distance Dm accordingly does not apply any downward force to the second valve section 65 or force of detaching the second sealing element 64c from the second seat element 66c. The second valve section 65 is structured to have the lower density than the first valve body 62. This makes the second valve section 65 likely to remain at the position of closing the connection hole 64b of the first valve section 61 even when the float assembly 52 goes down to its lowermost position. Once the second valve section 65 is detached from the first valve section 61 to open the connection hole 64b, the liquid fuel flows into the first valve section 61 to readily open the connection conduit 31b. Since the second valve section 65 is not easily opened as mentioned above, however, even in the event of application of microvibration to the fuel cutoff valve 10 caused by, for example, vibration of the vehicle body, the structure of the fuel cutoff valve 10 keeps the upper valve plug 60 at the seal position of the connection conduit 31b and accordingly maintains the sufficient sealing property.

In the fuel cutoff valve 10 of this embodiment, the second float 54 is structured to have the lower density than the first valve body 62. It is possible for the second float 54 to reduce weight by this low-density structure. This low-density structure of the second float 54 makes the float assembly 52 more buoyant. The upward force of the float assembly 52 further makes the second valve section 65 less likely to open and thus more effectively maintains the sufficient sealing property. While the total weight of the float assembly 52 is reduced, the weight of the outer first float 53 is not reduced. The weight reduction of the float assembly 52 accordingly does not lower the abrasion resistance of the outside of the float assembly 52.
(4) Effects and Advantages of Embodiment

The structure of the fuel cutoff valve 10 of the embodiment has the following effects and advantages.
(4)-1 When the liquid fuel level in the fuel tank FT reaches or exceeds the predetermined liquid level FL1 of blocking the opening 39b in the course of fuel supply, the inner pressure of the fuel tank FT increases to activate the auto stop function of the fuel cutoff valve 10.
(4)-2 The support convex 66b formed on the upper valve plug 60 is held at one supporting point 55a of the support plane 56a formed on the valve support member 55 of the float assembly 52. The center of gravity of the upper valve plug 60 is positioned below the supporting point 55a, so that the upper valve plug 60 is balanced about the supporting point 55a to keep the stable attitude. Even when the float assembly 52 is slanted by, for example, inclination of the vehicle body, the upper valve plug 60 keeps the stable horizontal attitude, while being appropriately seated on and detached from the first sealing element 31c of the connection conduit 31b to maintain the high sealing property.
(4)-3 The upper valve plug 60 is self-retained at the stable attitude by the principle of the balancing toy. This arrangement reduces the required pressing force of the upper valve plug 60 against the first sealing element 31c and the required valve-closing upward force of the float assembly 52 and thus effectively responds to even a small increase in liquid fuel level caused by, for example, inclination of the vehicle body. Even when the support convex 66b of the upper valve plug 60 comes into contact with the support plane 56a of the float assembly 52 at a position deviated from the axial center of the float assembly 52, the upper valve plug 60 is balanced about the support convex 66b and is thus retained at the stable attitude.
(4)-4 With an increase in liquid fuel level in the fuel tank FT in the course of fuel supply, the fuel vapor accumulated in the upper space of the fuel tank FT goes up as the upward current in the valve chest 30S and enters the supporting hole 62c of the first valve body 62. The fuel vapor then flows through the space defined by the supporting hole 62c and the guide cylinder 66f and is released out through the communication holes 62e. The upward current of the fuel vapor flowing through the supporting hole 62c is thus not accumulated in the upper space of the supporting hole 62c but is released through the communication holes 62e. This arrangement effectively prevents a local increase of the inner pressure of the supporting hole 62c and resulting generation of the force of detaching the second valve section 65 from the first valve section 61. The guide ribs 62f of the first valve body 62 are formed on the inner wall of the supporting hole 62c and effectively guide the second valve section 65 relative to the first valve body 62 without inclining the second valve section 65. Namely the second valve section 65 moves up and down in the vertical direction without being inclined, and the second seat element 66c is seated on the second sealing element 64c with the high sealing property. This arrangement prevents a potential trouble caused by the lowered sealing property, for example, outflow of the liquid fuel via the broken seal through the connection hole 64b and the connection conduit 31b to the outside.
(4)-5 The upper valve plug 60 submerged in the liquid fuel is subjected to the buoyancy to be retained at the position of closing the connection conduit 31b. Even in the event of application of microvibration to the fuel cutoff valve 10 caused by, for example, vibration of the vehicle body, the structure of the fuel cutoff valve 10 keeps the upper valve plug 60 at the seal position of the connection conduit 31b and accordingly maintains the sufficient sealing property.
(4)-6 The valve support member 55 is located in the partition wall 66a of the second valve section 65 across a predetermined gap. Even when a force is applied in the direction of inclining the upper valve plug 60 supported in the bobbing state, this arrangement prevents significant inclination of the second valve section 65 relative to the float assembly 52 and maintains the sufficient sealing property.
   (5) Second Embodiment

In the fuel cutoff valve 10 of the first embodiment, only the second float 54 of the float assembly 52 is structured to have the lower density than the first valve body 62. In a fuel cutoff valve of a second embodiment, both the first float 53 and the second float 54 of the float assembly 52 are structured to have the lower densities than the first valve body 62. For example, the first float 53 and the second float 54 may be both made of PA6.

This arrangement reduces the weight of the whole float assembly 52 and makes the float assembly 52 more buoyant, thus more effectively maintaining the sufficient sealing property even in the event of application of microvibration to the fuel cutoff valve 10.

In one modified example of the second embodiment, only the first float 53 of the float assembly 52 may be structured to have the lower density than the first valve body 62. For example, the first float 53 and the second float 54 may respectively be made of PA6 and POM.
(6) Other Aspects

The first and the second embodiments and their modified examples discussed above are to be considered in all aspects as illustrative and not restrictive. There may be many other modifications, changes, and alterations without departing from the scope or spirit of the main characteristics of the present invention. Some examples of possible modification are given below.

(I) In the first and the second embodiments described above, weight reduction of at least one specified component, for example, the second valve section 65, the first float 53, or the second float 54, is attained by selecting the optimum resin material among various resin materials including polyethylene, POM, PPS, and PA. In one modification, the resin material may be mixed with fine hollow spherical particles for the purpose of weight reduction. One typical example of the fine hollow spherical particles is Scotchlite Glass Bubbles (manufactured by Sumitomo 3M Limited, range of particle diameter 15 to 135 μm, average particle diameter 30 to 70 μm). Some applications of such modification are explained below.

In one application to the second embodiment, both the first float 53 and the second float 54 of the float assembly 52 are made of the PA6 resin material mixture having the Scotchlite Glass Bubbles content of 30%. The first float 53 and the second float 54 of the float assembly 52 are then structured to have the lower density of 1.0 [g/cm³]. This arrangement attains further weight reduction compared with the structure of the second embodiment, thus more effectively maintaining the sufficient sealing property in the event of application of microvibration to the fuel cutoff valve submerged in the liquid fuel by, for example, inclination of the vehicle body.

In one application to the first embodiment, only the second float 54 of the float assembly 52 is made of the PA6 resin material mixture having the Scotchlite Glass Bubbles content of 30%. In one application to the modified example of the second embodiment, only the first float 53 of the float assembly 52 is made of the PA6 resin material mixture having the Scotchlite Glass Bubbles content of 30%. These applications enable the weight reduction of the float assembly and make the float assembly more buoyant, thus effectively maintaining the sufficient sealing property of the fuel cutoff valve. In another application, the second valve section 65 may be made of the PA6 resin material mixture having the Scotchlite Glass Bubbles content of 30%.

The content of Scotchlite Glass Bubbles is not restricted to 30% but may be changed according to the requirements. The higher content of Scotchlite Glass Bubbles enables further weight reduction, while the higher content of PA6 ensures the higher abrasion resistance. Scotchlite Glass Bubbles is only one example of the fine hollow spherical particles but may be replaced with any of various types of fine hollow spherical particles (for example, glass particles or ceramic particles). Small hollow tubular bodies, instead of the fine hollow spherical particles, may be mixed with the resin material to lower the specific gravity. The base resin material is not restricted to PA6 but may be any of various resin materials, for example, PA, polyethylene, POM, or PPS.

(II) In the modified example (I) described above, the second valve section 65 is made of the resin material mixed with the fine hollow spherical particles. It is, however, not essential to make the whole second valve section 65 of the resin material mixed with the fine hollow spherical particles, but only a specific part of the second valve section 65, for example, an inner section of the second valve section 65 other than an outer layer, may be made of the resin material mixed with the fine hollow spherical particles. Similarly the target of weight reduction may not be the whole first float 53 or the whole second float 54 but may be only a specific part of the first float 53 or the second float 54.

(III) In the modified example (I) described above, the weight reduction of the specified component is attained by mixing the resin material with the fine hollow spherical particles. One modification may use a foamed resin, instead of the resin material mixed with the fine hollow spherical particles, for the purpose of weight reduction. The foamed resin is produced by injecting carbon dioxide or another suitable gas into polyacetal, polyamide, polyethylene, or another suitable polymer. This modified structure also attains weight reduction of the second valve section 65, the first float 53, and the second float 54. The target of weight reduction to be made of the foamed resin may not be the whole specified component but may be at least part of the specified component.

(IV) In the first and the second embodiments described above, weight reduction of at least one specified component, for example, the second valve section 65, the first float 53, or the second float 54, is attained by selecting the optimum resin material among various resin materials including polyethylene, POM, PPS, and PA. In one modification, the specified component made of the selected optimum resin material, for example, polyethylene, POM, PPS, or PA, may be designed to have an inner hollow space that is to be filled with a foam.

FIG. 9 is a sectional view showing the structure of an upper valve plug 60A in another fuel cutoff valve of one modified example. The fuel cutoff valve of this modified example has a similar structure to that of the fuel cutoff valve 10 of the first embodiment, except a second valve section 65A of an upper valve plug 60A. The second valve section 65A is made of the resin material PA6 containing 30% of glass fibers as in the first embodiment and is designed to have an inner hollow space 100 that is to be filled with a foam. The foam is, for example, a foamed resin produced by injecting carbon dioxide or another suitable gas into polyacetal, polyamide, polyethylene, or another suitable polymer. This structure enables further weight reduction of the second valve section 65A, compared with the structure of the second embodiment.

(V) In the first and the second embodiments described above, both the second valve section 65 and the float assembly 52 are the target of weight reduction. In one modification, only the second valve section 65 may be structured to have the lower density than the first valve body 62. For example, the first valve body 62 and the second valve section 65 may respectively be made of POM and 30% glass fiber-containing PA6, while the first float 53 and the second float 54 of the float assembly 52 are made of POM.

(VI) In the first and the second embodiments described above, the fuel cutoff valve is attached to the outer face of the top wall of the fuel tank. The technique of the invention is similarly applicable to a fuel cutoff valve of in-tank type, which is attached to the inner face of the top wall of the fuel tank.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A fuel cutoff valve attached to an upper portion of a fuel tank and configured to open and close a connection conduit for connecting inside of the fuel tank with outside and thereby allow and block communication of the inside of the fuel tank with the outside, the fuel cutoff valve comprising:
a casing structured to form a valve chest of connecting the fuel tank with the connection conduit;
a float assembly located in the valve chest and configured to move up and down along a vertical axis with an increase or a decrease of buoyancy corresponding to a variation in level of liquid fuel in the valve chest; and
an upper valve plug placed above the float assembly to be movable along the vertical axis in a preset distance from the float assembly and configured to open and close the connection conduit by a downward motion and an upward motion of the float assembly under a condition that the liquid fuel reaches a predetermined fluid level,
the upper valve plug having:
a first valve section including (i) a first valve body designed to have a support hole, (ii) a first seat element provided on the first valve body to open and close the connection conduit, and (iii) a connection hole formed to pass through the first seat element and connect with the support hole and designed to have a smaller passage area than a passage area of the connection conduit; and
a second valve section including (i) a second valve body located in the support hole to be movable along the vertical axis and (ii) a second seat element provided on the second valve member to open and close the connection hole,
wherein the second valve section is structured to have a lower density than the first valve body.

2. The fuel cutoff valve in accordance with claim 1, wherein the float assembly has:
a first float formed in a cup shape to have a bottom-opened receiving hole; and
a second float located in the receiving hole to be integrated with the first float, and
the second float is structured to have a lower density than the first valve body.

3. The fuel cutoff valve in accordance with claim 2, wherein the first float is structured to have a lower density than the first valve body.

4. The fuel cutoff valve in accordance with any one of claims 2, the float assembly has a valve support member formed in an upper portion of the float assembly to support the upper valve plug, and
the second valve section has a support convex held on the valve support member, where a center of gravity of the second valve section is located below a supporting point around which the support convex is balanced on the valve support member.

5. The fuel cutoff valve in accordance with claim 4, wherein the first valve body has a cylindrical side wall, and the second valve body has a guide cylinder located in the first valve body.

6. The fuel cutoff valve in accordance with claim 5, wherein the first valve body has a first catching claw, and the second valve body has a second retaining claw engaging with the first catching claw, where a position of engagement of the first catching claw with the second retaining claw is located below the supporting point.

7. The fuel cutoff valve in accordance with claim 1, wherein the float assembly has:
a first float formed in a cup shape to have a bottom-opened receiving hole; and
a second float located in the receiving hole to be integrated with the first float, and
the first float is structured to have a lower density than the first valve body.

8. The fuel cutoff valve in accordance with any one of claims 7, the float assembly has a valve support member formed in an upper portion of the float assembly to support the upper valve plug, and
the second valve section has a support convex held on the valve support member, where a center of gravity of the second valve section is located below a supporting point around which the support convex is balanced on the valve support member.

9. The fuel cutoff valve in accordance with claim 8, wherein the first valve body has a cylindrical side wall, and the second valve body has a guide cylinder located in the first valve body.

10. The fuel cutoff valve in accordance with claim 9, wherein the first valve body has a first catching claw, and the second valve body has a second retaining claw engaging with the first catching claw, where a position of engagement of the first catching claw with the second retaining claw is located below the supporting point.

11. The fuel cutoff valve in accordance with any one of claims 1, the float assembly has a valve support member formed in an upper portion of the float assembly to support the upper valve plug, and
the second valve section has a support convex held on the valve support member, where a center of gravity of the second valve section is located below a supporting point around which the support convex is balanced on the valve support member.

12. The fuel cutoff valve in accordance with claim 11, wherein the first valve body has a cylindrical side wall, and the second valve body has a guide cylinder located in the first valve body.

13. The fuel cutoff valve in accordance with claim 12, wherein the first valve body has a first catching claw, and the second valve body has a second retaining claw engaging with the first catching claw, where a position of engagement of the first catching claw with the second retaining claw is located below the supporting point.
